(19) United States
(12) Patent Application Publication
(10) Pub. No.: US 2008/0267844 A1
(43) Pub. Date: Oct. 30, 2008

(54) REACTOR HEATER

(76) Inventor: Duncan Guthrie, Alpheton (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/739,749

(22) Filed: Apr. 25, 2007

(51) Int. Cl. B01J 19/00

(52) U.S. Cl. 422/198

(57) ABSTRACT

A heater for supplying heat to a plurality of detachable reactors is provided, the heater including a plurality of independent heating zones, each heating zone including: a hot-air heater; an output port adapted for connection to a heating cavity of a reactor; an exhaust port adapted for connection to the heating cavity of said reactor; and an air source arranged to cause air heated by said hot-air heater to pass through said output port and to return through said exhaust port when a reactor is attached to said output nozzle and said exhaust port. The heater can supply highly controllable heat to a plurality of different types of reactor while controlling the temperature of each individually. A kit containing a heater and a variety of reactors is also provided.

### FIELD OF THE INVENTION

The present invention relates to a reactor heater and associated reactors.

### BACKGROUND

Reactors for use in flow chemistry provide a chamber or cavity in which a chemical reaction in a fluid occurs. Two general types of reactors are known: a homogeneous reactor in which a fluid or a mixture of fluids are reacted as they pass through the chamber, and a heterogeneous reactor in which a media is contained within the reactor and fluid passing through the reactor either reacts with the media or a reagent attached to the surface of the media or reacts in a manner which is catalysed by the media.

As with many chemical reactions, it is often desirable to control the temperature of reactions occurring in the chamber, which may be exothermic or endothermic.

However, many types of reactor exist and it can often be time consuming to the chemist to set up a particular reactor and provide for heating and temperature control for the reaction. Frequently chemists have a need to set up several parallel and/or sequential reactions of differing types and with differing requirements.

### SUMMARY

It is an object of the present invention to provide a heater for a reactor which can accommodate a plurality of types of reactor.

It is a further object of the present invention to provide a heater which is capable of independent control of the temperature of a plurality of different reactors.

One aspect of the present invention provides a heater for supplying heat to a plurality of detachable reactors, the heater including a plurality of independent heating zones, each heating zone including: a hot-air heater; an output port adapted for connection to a heating cavity of a reactor; an exhaust port adapted for connection to the heating cavity of said reactor; and an air source arranged to cause air heated by said hot-air heater to pass through said output port and to return through said exhaust port when a reactor is attached to said output nozzle and said exhaust port.

The air source is preferably a fan, but could be any other form of air source, such as a nozzle through which a supply of compressed gas or air is allowed to expand. The air source is preferably arranged so that a mass flow of air is driven through the heater and into the heating cavity of an attached reactor.

Preferably each heating zone further includes a temperature sensor for connection to said reactor. In an exemplary embodiment of the invention the temperature sensor is a thermocouple, but other temperature sensors may be used. Advantageously the temperature sensor may be arranged to contact with the external wall of a cavity in the reactor through which, in use, the fluid to be analysed or reacted flows.

The heater preferably further includes a control unit which is arranged to control said hot-air heater and/or said air source of a heating zone in response to the temperature sensed by said temperature sensor of said heating zone. A single control unit may be provided for the heater as a whole, or separate control units may be provided which control the temperature of one or more of the heating zones.

In a preferred embodiment of the invention an input device is provided through which a user can set a target temperature for at least one of the heating zones. The control unit is arranged to control the hot-air heater and the air source to maintain the temperature sensed by the temperature sensor of that heating zone at said target temperature.

The input device may take the form of a keypad, dial or other manual input located on the heater itself. Alternatively, a remote control link (such as a serial cable) may be provided and the input device may include a computer such as a notebook/laptop computer, or a personal computer.

Preferably the input device allows the independent setting of target temperatures for each of the plurality of heating zones. The control unit(s) may be arranged to independently store the target temperature for each of the zones, and to independently control the hot-air heaters and air sources of each of the zones so as to achieve and maintain the target temperature of each zone.

The heater may have a display for displaying information relating to one or more, preferably all, of the heating zones. This information may include one or more of the temperature of the heating zone, the target temperature for the heating zone and whether the heating zone is currently increasing or reducing the temperature.

The air source(s) may also be controllable to direct ambient air into the heating cavity in order to reduce the temperature of the reactor.

Preferably each heating zone has one or more attachment points which are arranged to allow the connection of a plurality of different types of reactor to each of said heating zones.

A further aspect of the present invention provides a kit of parts comprising a heater for supplying heat to a plurality of detachable reactors, and at least two different types reactors, wherein: the heater includes a plurality of independent heating zones, each heating zone including: a hot-air heater; an output port adapted for connection to a heating cavity of a reactor; an exhaust port adapted for connection to the heating cavity of said reactor; and an air source arranged to cause air heated by said hot-air heater to pass through said output port and to return through said exhaust port when a reactor is attached to said output nozzle and said exhaust port; and further wherein: each of said types of reactor can be releasably connected to any one of said independent heating zones.

The heater provided in this aspect and the first aspect above can provide heat to a variety of different types of reactors, preferably including homogeneous and heterogeneous reactors. The different types of reactor in the present aspect can be interchanged with each other in connection to the heater to provide flexibility to the operator.

Different reactors when connected to the heater can, if desired, be interconnected so that, for example the reacted output from a first reactor may be connected to the input of a second reactor. Different reactions can be prepared in each of the reactors, and different temperatures maintained as required.

A preferred form of reactor for this aspect of the invention has a first cavity through which flows, in use, a fluid to be analysed or reacted, and a second cavity (the “heating cavity”) through which flows, in use, the hot air from the heater. Preferably the reactor is arranged so that the second cavity encloses the first cavity. More preferably the reactor includes a third cavity which insulates the second cavity to prevent heat loss to the atmosphere from the second cavity. As an example, the third cavity is a vacuum cavity.

Preferred embodiments include reactors which are constructed so as to allow the fluid flowing in the chamber to be viewed from externally. This may be accomplished by providing cavities which are transparent, for example where the walls or part of the walls of the cavity are constructed from glass. The use of hot-air to heat such reactors is advantageous as it is transparent and does not distort the viewing of the fluid flowing in the chamber.

Further advantages of using hot air as a heating medium for the heater are that it is clean to use and does not require draining from the system prior to change of a reactor. In this way reactors connected to the heater can be easily and quickly interchanged, compared to systems using, for example, liquid heating media. Air also has the advantage of keeping the total heat capacity of the system (heater and reactor) low which allows rapid temperature increases for a given power input. Similar rapid temperature decreases are also facilitated by this low heat capacity.

In order to ensure uniform heating of the fluid being reacted, the hot air which is used to heat the reactor is preferably agitated so as to create non-laminar flow around the cavity containing the fluid to be reacted. This may be achieved by arranging an intake port of the heating cavity of the chamber so as to cause the incoming hot air to swirl. In an alternative arrangement, baffles may be provided within the heating cavity to disrupt the flow of air through that cavity.

In order to provide accurate temperature measurement of the cavity in which the fluid being reacted is flowing, the heater and reactors are preferably arranged such that a temperature sensor forming part of the heater is positioned in the heating cavity of the reactor and detects the temperature of a wall separating that heating cavity from the cavity in which the fluid being reacted is flowing.

A further aspect of the present invention provides an apparatus for flow chemistry including a heater and a plurality of types of reactor detachably connected to said heater and arranged to be heated by said heater, wherein: each of said types of reactor has a first cavity through which flows, in use, a fluid to be analysed or reacted; and a second cavity through which flows, in use, hot air from said heater; the heater includes a plurality of independent heating zones, each heating zone including: a hot-air heater; an output port connected to the second cavity of one of said reactors; an exhaust port connected to the second cavity of said reactor; an air source arranged to cause air heated by said hot-air heater to pass through said output port and to return through said exhaust port.

### BRIEF DESCRIPTION OF THE DRAWINGS

Preferred embodiments of the present invention will now be described in relation to the attached drawings, in which:

FIG. 1 shows a reactor heater according to a first embodiment of the present invention;

FIG. 2 is a cross-section of the reactor heater of the first embodiment;

FIG. 3 is an expanded view of a reactor which forms part of a second embodiment of the invention;

FIG. 4 is a second expanded view of the reactor of FIG. 3;

FIG. 5 is a plan view of the reactor of FIG. 3;

FIG. 6 is a vertical cross-section through the reactor of FIG. 3; and

FIG. 7 is a graph of the temperature response of a heating zone of the reactor heater of an embodiment of the present invention.

### DETAILED DESCRIPTION OF PREFERRED EMBODIMENTS

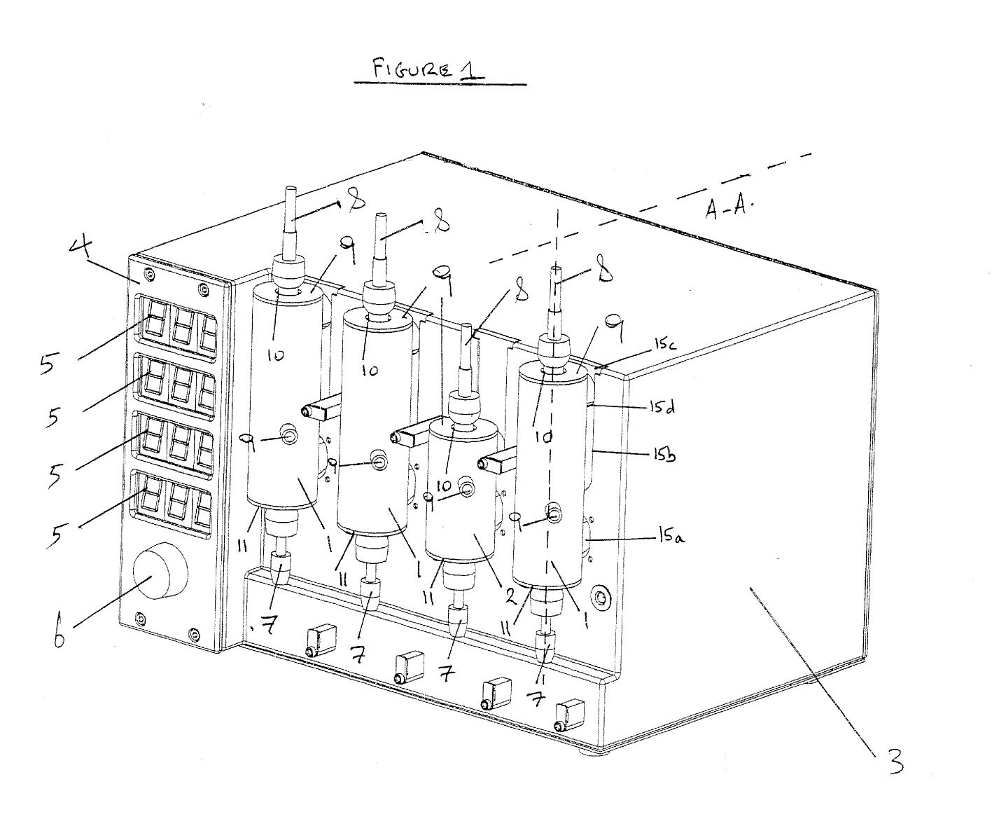

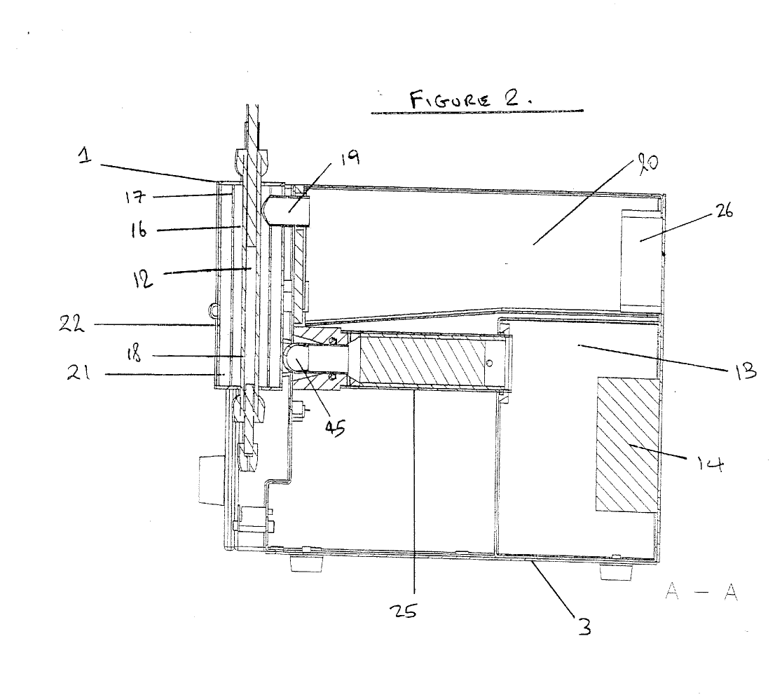

A first embodiment of a heater according to the present invention is shown in FIG. 1. FIG. 2 shows a cross-section of the heater of FIG. 1 along the line A-A.

The heater 3 of FIG. 1 has four independent heating zones to which reactors 1 are attached. Although all of the reactors shown in FIG. 1 are of the columnar type, this is not limiting, and different reactors can be used at one, several or all of the independent heating zones. Alternative reactors include helical or spiral reactors, an example of which is described below in more detail, or other reactors which are well known in the art.

The heater of this embodiment is arranged so that different types of reactor can be readily coupled to and disconnected from each of the independent heating zones. The front face of the heater has a plurality of connection points to which the reactors can be physically attached and which support the reactors. In the embodiment shown in FIG. 1, these connection points include, for each connection zone, a primary connection point 15a and a slot 15b into which a slideable plate 15c is inserted for each heating zone. The slideable plate 15c has a circular hole 15d and a magnetic steel section in the front face. The slot 15b and slideable plate 15c allow reactors of different shapes and sizes to be attached to the heater 3.

The primary connection point 15a of the preferred embodiment is a circular hole into which the input tube of the reactor 1 is inserted. An elastomeric seal within the primary connection point makes a seal between the reactor and the heater. To withstand the high temperature, the elastomeric seal is formed from a perfluoroelastomer such as Kalrez®. The exhaust tube of the reactor is inserted into a hole in the slidable plate 15c.

A magnet fixed to the reactor body, on making contact with the steel element within the slideable plate 15c, retains the reactor in contact with the front face of the heater. To provide for a high attachment force, a rare-earth magnet is used, for example a Neodynium magnet.

However, other methods of connection, including, but not limited to, bayonet, plug and socket connections, clamp or clip connections and any other connection mechanisms well known to the person skilled in the art, may be provided. In the preferred embodiment all of the heating zones are provided with identical connection mechanisms to allow interchange of the reactors between the different heating zones. In a particularly preferred arrangement, each heating zone is provided with the primary and secondary connections as previously described. The magnetic connection into the slideable plate ensures that a wide variety of types and sizes of reactor can be connected.

Each reactor 1 has input 7 and output 8 couplings which are attached, in use, to pipes (not shown) which supply and take away the fluids which are to be the subject or result of the chemical reactions or analysis in the reactor.

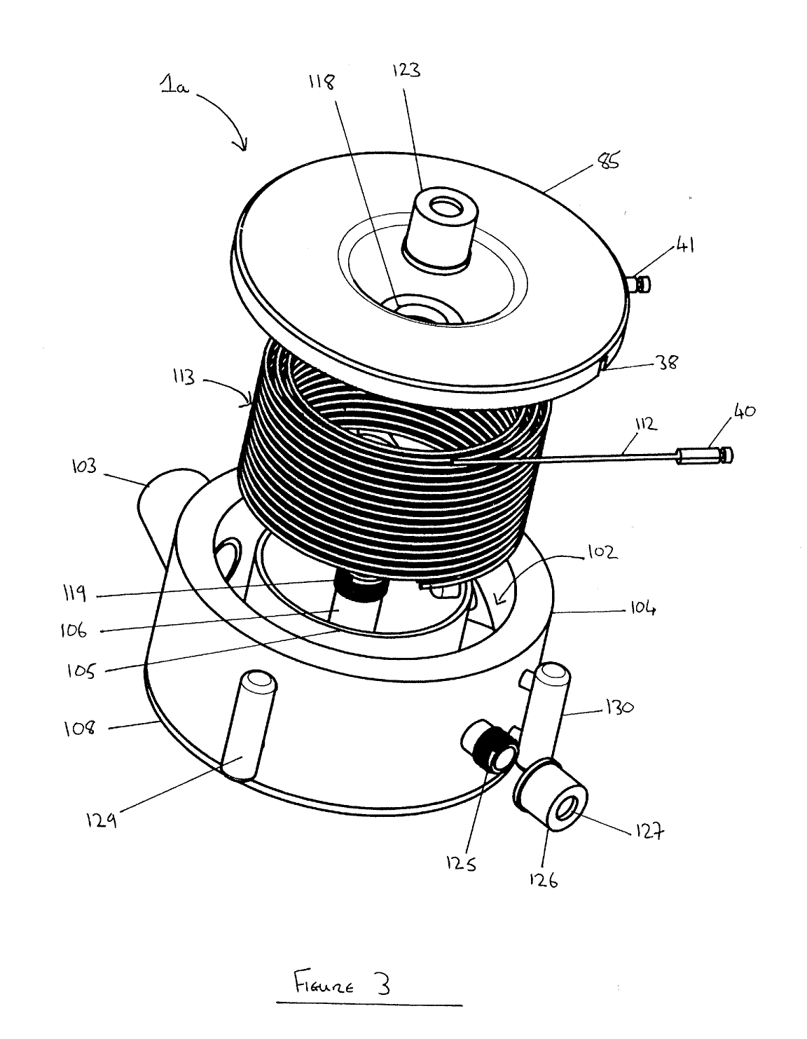

In a particularly preferred embodiment, the reactors 1 have a three-cavity structure, shown in cross-section in FIG. 2. The innermost cavity 12 is the reactor cavity through which the fluid to be reacted and/or analysed passes. Depending on the type of reactor, this cavity may contain solid media (a heterogeneous reactor) to act as a catalyst or to support solid reactants on its surface. In a columnar type of reactor such as that shown in FIGS. 1 and 2, the reactor cavity 12 is typically a single cylindrical pipe arranged along the vertical axis of the reactor. In the reactor of the type exemplified in FIGS. 3-6, the reactor cavity is a tightly would spiral of piping. Other configurations of the reactor cavity will be apparent to persons skilled in the art.

Surrounding the reactor cavity 12 is a heating cavity 16 which is connected to the intake and outlet ports of the reactor. Hot air 3 provided by the heater flows through this cavity and transfers heat energy to the wall 18 separating the heater cavity and the reactor cavity. The heat energy is then transferred from the wall 18 to the fluid flowing in the reactor cavity 12. No fluid communication is provided between the reactor cavity 12 and the heating cavity 16.

Surrounding the heating cavity 16 is an insulating cavity 21. This cavity make take several forms (and indeed need not be a cavity as such, but may simply be an insulating layer), but is preferably a vacuum cavity to prevent or reduce heat loss from the heating cavity to the atmosphere. The insulating cavity 21 also serves to maintain the outer surface of the reactor 1 at ambient temperature and so allow an operator to readily handle the reactor after use without the risk of injury due to handling hot surfaces, or the need to allow the reactor 1 itself to cool down.

In the column type reactor shown in FIG. 1, the three cavities 12, 16, 21 are preferably concentric cylinders.

The walls of the cavities 12, 16, 21 are preferably made from translucent material such as borosilicate glass designed to withstand elevated temperatures. This allows the progress of the reaction or analysis being carried out in the reactor cavity 12 to be observed by the operator, notwithstanding the intervening walls 17, 18. Such visibility of the reaction or analysis is a further advantage of the use of hot air to heat the reaction as this fluid does not substantially alter the passage of light.

The exterior of the reactor is coated with a polymer coating 22 which is capable of retaining any broken glass within the reactor if the glass cylinders shatter for any reason.

Each reactor also has an entry port 9 for a thermocouple or other form of temperature sensor. The preferred arrangement uses a platinum thin film PT100 sensor (a type of Resistive Temperature Detector (RTD)), which has been found to offer a lower cost solution than a thermocouple, and also provide a greater degree of noise immunity.

The temperature sensor is inserted into the entry port 9 and positioned so as to abut the wall 18 separating the reactor cavity 12 and the heating cavity 16, on the side of the heating cavity. In this arrangement the temperature sensor can be used with many different reactors which are performing different reactions, but because the temperature sensor does not contact the fluid which is the subject of the reaction or analysis, there is no risk of cross-contamination between the reactors through the temperature sensor. However, an extremely accurate temperature measurement of the temperature of the fluid passing through the reactor cavity 12 can be achieved due to the direct contact with the wall 18 of the reactor cavity.

The entry port 9 for the temperature sensor and the temperature sensor itself interact so as to seal the entry port when the temperature sensor is in place and thus prevent hot air flowing in the heating cavity 16 from escaping through the entry port 9. A cover or similar mechanism may be provided for sealing the entry port 9 when the temperature sensor is not connected.

FIG. 2 shows a cross-section taken through the heater 3 of this embodiment. A hot-air heater 25 is mounted inside the case of the heater. A supply cavity 13 located towards the rear of the case supplies air at ambient temperature to the hot-air heater 25. A fan 14 is located at the inlet to the supply cavity 13 which forces air from the exterior of the heater into the supply cavity 13 and creates an overpressure in the supply cavity 13. In turn this overpressure forces air from the supply cavity 13 through the hot-air heater 25.

The hot-air heater 25 is controlled by the control unit of the heater (not shown), which maintains the temperature sensed by the temperature sensor at the desired temperature input by the operator. The control unit applies a varying degree of power to the electrical heating element of the hot-air heater 25, thereby controlling the temperature of the air exiting the heater and entering the heating cavity 16 of the reactor. In a preferred arrangement the power to the heating element is controlled by a pulse-width modulated signal, which allows precise control of the amount of energy supplied to the heater by the varying of the modulation.

The heater 25 is arranged to heat the air from the supply cavity 13 to temperatures of up to 150° C. Rates of temperature change of up to 80° C. per minute can be achieved.

The heated air from the heater 25 passes out through a nozzle 45 which, when a reactor 1 is mounted to the heating zone in question, is in fluid communication with the heating cavity 16 of that reactor. The nozzle 45 narrows in cross-section and is preferably configured such that the jet of hot air exiting the heater 3 and entering the reactor 1 meets the walls 17, 18 of the heating cavity 16 of the reactor in a substantially tangential direction and so is caused to swirl around the heating cavity.

The inducement of swirl is desirable to reduce laminar flow of the air in the heating cavity 16 of the reactor 1. If the flow through the heating cavity is too laminar, then there is a risk that the hot air provided from the heater 3 will not contact the wall 18 separating the heating cavity 16 from the reactor cavity 12, and so the amount of heat transferred to the reactor cavity will be significantly reduced. By inducing swirled flow, any laminar flow in the hot air entering the heating cavity is disrupted and an even distribution of the heating air can be achieved.

Other methods can be used to disrupt the flow of the air through the heating cavity 16 and thereby reduce the amount of laminar flow and improve the heat transfer from the air to the reactor cavity 12, including the provision of baffles or other mechanical interferents.

After the hot air from the heater has passed through the heating cavity 16 of the reactor, it exits the heating cavity 16 and returns to an exhaust cavity 20 of the heater 3 via an exhaust port 19. Whilst it is possible for the hot air to directly exit the heating cavity 16 into the atmosphere, this is generally undesirable as the hot air may affect the temperature of other parts of the reaction apparatus such as the output tubing, or interfere with reactions being conducted at other heating zones. By providing for the hot air to return to the exhaust cavity 20 within the heater 3, the output of hot air can be controlled and directed away from the reactors.

Furthermore, a plurality (in the preferred embodiment, three) of extractor fans 26 expel the hot air from the exhaust cavity 20 into the atmosphere, whilst simultaneously drawing a significant amount of ambient air into the exhaust cavity 20 (through ports, not shown). The ambient air mixes in the exhaust cavity 20 with the hot air prior to expelling the mixture in order to significantly reduce the temperature of the air which is expelled to the outside. Typically the fans 26 are arranged to draw 4 times more ambient air than the amount of hot air which exits the reactor 1. Such a mixing process can reduce hot exhaust from the reactor at 150° C. to expelled air at approximately 50° C. or less, which is safer.

A typical air flow rate through the heater 3 and reactor 1 is 0.8 cubic metres per minute for reactors with reactant flow rates of up to 2 ml per minute. However, the air flow rates can be adjusted to provide greater flows of heating air for larger scale reactions in order to provide the same level of temperature control. Similarly, for smaller or slower reactions, the flow rate can be reduced.

In addition to controlling the power supplied to the heater 25, the control unit may also control the flow rate of air through the heating cavity 16.

An advantage of using hot air to heat the reactors is that it is possible to switch very quickly from heating to cooling. Cooling is accomplished by directing air at ambient temperature into the heating cavity 16. The control unit may increase the flow rate of air through the heating cavity 16 in order to increase the cooling rate if desired. In order to maximise the rate of cooling, a bypass passage may be provided to allow the cooling air to bypass the heater 25. The bypass passage can be used to prevent residual heat from the heater 25 being provided in the initial stages of cooling, and may also allow for a greater flow rate of cooling air.

Traditional heaters for flow chemistry have not achieved rapid cooling rates. However, the present embodiment can achieve a cooling from 150° C. to 30° C. in less than 6 minutes.

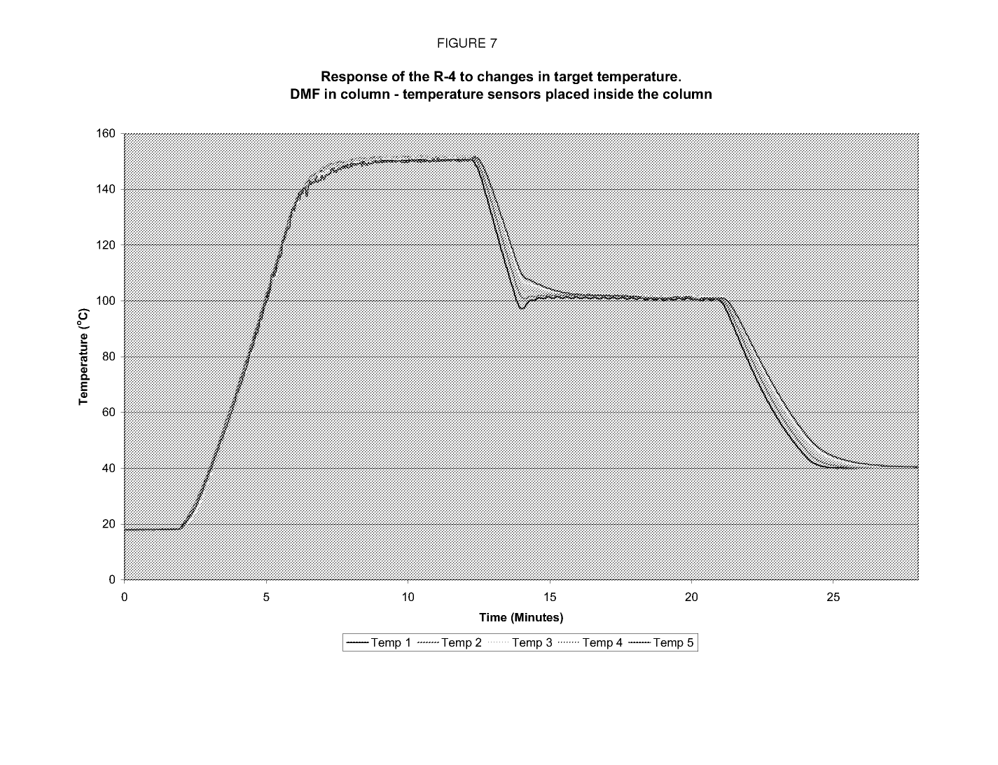

FIG. 7 shows the temperature response of a reactor inserted into one of the independent heating zones in the heater in response to changes in target temperature. Five individual temperature sensors (producing the respective traces shown in FIG. 7) were placed within the reactor, equispaced along the working length of the reactor. The reactor was filled with a solvent, di-methyl formamide, having a boiling point above 150° C. The traces show that rapid increases and decreases in temperature in response to changes in target temperature can be achieved and that when the temperature has stabilized then the temperature along the length of the reactor is consistent, thus enabling reactions to progress under isothermal conditions.

The target temperature for the reactor in FIG. 7 was changed at 2 minutes, 12 minutes and 21 minutes on the time axis. From FIG. 7, it can be seen that:

a) a target temperature of 150° C. was reached from an initial temperature of 18° C. in approximately 5 minutes;

b) a target temperature of 100° C. was reached from a previous temperature of 150° C. in approximately 3 minutes;

c) a target temperature of 40° C. was reached from a previous temperature of 100° C. in approximately 4 minutes; and

d) once stablized at a set temperature, the variation in the temperature measured anywhere along the working length of the reactor is within 2° C.

A control panel 4 located on the front of the heater has four individual digital displays 5. These displays show data relating to each of the independent heating zones in the heater. A dial 6 is provided which can be used to set target temperatures for each of the displays.

The control unit of the heater is arranged to display on the digital displays 5, at the choice of the operator, one or more of: the current temperature of the heating zone; the target temperature of the heating zone; and whether the heating zone is increasing or decreasing temperature. The skilled person will appreciate that additional controls can be provided on the control panel 4 and that the control unit can be arranged to display further useful information on the control panel either on the digital displays 5 or through other mechanisms.

Alternatively or additionally the target temperatures and other inputs can be provided from an external source, such as a personal computer, which is connected to the control unit. In a preferred embodiment such remote control is provided by an RS232 interface which provides for the receipt of simple serial commands.

FIGS. 3-6 show a reactor 1a which is an example of a different type of reactor that can be used in conjunction with the heaters of the present invention.

A second embodiment of the present invention provides a kit containing a heater 3 according to the first embodiment above, a column type reactor 1 of the type described above and a helical tube type reactor 1a of the type shown in FIGS. 3-6.

A third embodiment of the present invention provides an apparatus for flow chemistry in which both types of reactor 1 and 1a described herein are attached to a heater 3 according to the first embodiment above.

A more detailed description will now be provided of the second type of reactor 1a. FIG. 3 shows a reactor 1a incorporating an outer cylinder 104 and an inner cylinder 105 which project from a base plate 108. The inner and outer cylinders are shown as co-axial where the inner cylinder is located within the outer cylinder.

The cylinders 104, 105 are preferably of translucent material such as borosilicate glass designed to withstand high temperatures. For reaction conditions that require high pressures the cylinders can be manufactured from a tough material such as stainless steel, stainless steel being more suitable for containment of spillage or debris in the event of failure of the reactor wall.

Reactor 1a operates in conjunction with a heater as described in the first embodiment above which blows hot air into the reactor through an inlet coupling 103 and receives exhaust from an outlet coupling 107 which traverse the outer cylinder 104. The hot air from the heating unit is expelled from coupling 103 into an annular heating chamber 102 that is formed between outer cylinder 104 and inner cylinder 105.

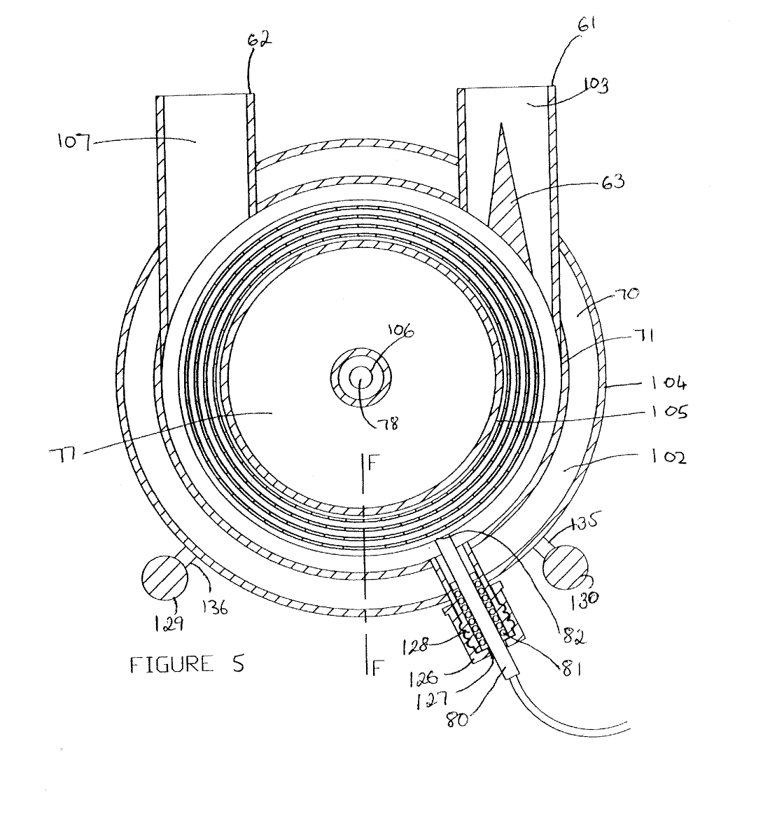

The outer cylinder 104 incorporates a hollow wall which form an annular cavity 70 (see FIG. 5) that is permanently sealed. A vacuum is created within the annular cavity to thermally insulate the outer cylinder's external surface from the heat being emitted from the annular heating chamber 102 during use.

The inner cylinder surrounds a column 106 and projects from said base plate 108. The annular region contained within the inner cylinder 105 and the column 106 is preferably filled with an insulating material such as polyurethane foam. The hot air circulates around the annular heating chamber 102 and exits at exhaust coupling 107 which is located substantially central and perpendicular to the reactor's outer cylinder surface.

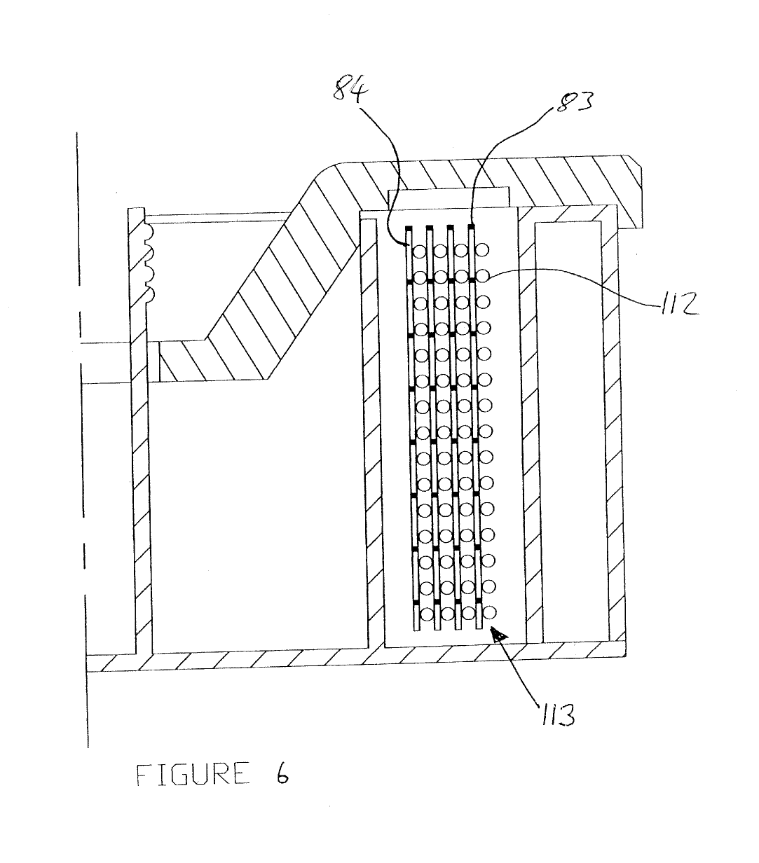

A length of small bore tubing 112 is configured into a coil 113 so that it can be housed within the annular heating chamber 102. FIG. 6 shows the preferred configuration for the tubing as a coil having multiple layers each layer wound onto a former 83. The former is manufactured with apertures 84 to allow the heating fluid to pass through and around the small bore tubing 12. A suitable material for the formers is stainless steel that has been punched with a series of closed pitched holes to give a sheet with an open area of preferably 60% or more. Each layer of the tubing is wound onto the former in the form of a helix where the pitch of the helix is at least twice the tube diameter. The apertures between adjacent tubes allow the heating fluid to circulate freely. The material from which the tube 112 is manufactured is chosen to suit the temperature and pressure of the reaction conditions and the chemical nature of the reaction fluids. Examples of materials used are; Polytetraflouroethylene (PTFE), Perfluoroalkoxy (PFA), Fused Silica, stainless steel grade 316L and Inconel (registered trade mark) grade 600 and Hastelloy (registered trade mark) grade C276.

Beneficially a coil 113 can be constructed in the manner described but with a second elongate tube of significantly smaller internal volume co-wound together with the larger volume elongate tube. The smaller coil creates a smaller reactor. The smaller reactor should be manufactured from the same material as the larger reactor and with identical internal diameter. The smaller reactor can be used to optimise reaction conditions while minimising usage of reagents. Once the preferred reaction conditions have been determined the larger reactor can be connected and the same identical reaction completed but at higher flow rates to generate a larger quantity of material. For example a 10 to 1 volume ratio between the two co-wound reactors has been successfully used.

The coil 113 is held within the heating chamber by a circular lid 85. The lid 85 has a recessed central aperture 118. The column 106 that is fixed centrally to base plate 108 incorporates a threaded upper portion 119. Threaded portion 119 of the column locates through the recessed central aperture 118 in the circular lid 85. To close the reactor the circular lid is placed in abutment against the upper annular surface of the outer cylinder 104. The circular lid 85 also abuts the upper annular surface of the inner cylinder 105 and therefore encloses the annular heating chamber 102. The circular lid 85 is secured into position via a locking nut 123 which is screwed on to the protruding threaded portion 119 of column 106.

The loose tails 112 of the coil incorporate couplings 40 and 41 and exit the reactor 1a when the circular lid is fitted via the two square slots 38 that are located in the bottom surface of the circular lid 85.

The reactor 1a allows easy removal of the coil 113 whilst the reactor is either still attached to the heating unit or when it is detached from the heating unit. The replacement of the coil will be required if adjustments are required for flow rate and/or temperature exposure time period of the reagents within the reactor. The flow rate is chosen so that the necessary temperature exposure time for the reactants within the reactor can be achieved. For a fixed flow rate, the temperature exposure time period is dependent upon the internal volume of the small bore tubing 112 that is situated in the heating cavity 102.

The reactants are mixed together, externally to the reactor, by a mixing chamber (not shown) in a known manner. It is preferred that this mixture is carried out upstream from the reactor.

To ensure uniform heating of the reaction fluids within the small bore tubing 112 configuration a high flowrate of heating fluid is fed into the compact heating cavity 102 within the reactor. The significant agitation of the heating fluid as it moves through the heating cavity 102 and around the tubing coils 113 ensures a uniform temperature with the coils 113. It is preferred that the compact annular configuration of the heating cavity 102 will not incorporate any voids which may impede the high performance heating and cooling functionality required from the reactor.

Projecting perpendicularly and placed substantially central on reactor's outer cylinder wall is a temperature sensor entry tube 125 that enables temperature monitoring of the tubing 112 within the heating cavity 102. The end portion of the temperature sensor entry tube incorporates a thread 128. When a thermocouple 82 (of a kind known in itself), or other temperature sensor, is inserted into the entry tube 125, with its probe end abutting the surface of the tubing 112, the thermocouple is secured into position by threading itself through aperture 127 within the locking cap 126 which is screwed onto the threaded end portion 128 of the entry tube 125. A coiled compression spring 81 applies pressure between the thermocouple and the surface of the tubing 112. Preferably the thermocouple is positioned such that the temperature of the coil is sensed close to end of the tubing 112 where the reactants enter. Positioning the temperature sensor such that the temperature is determined between 5% and 15% of its length into the reactor is found to produce good results.

Preferably the heating fluid to be used is hot air. Hot air has several advantages over heated liquids these include; rapid temperature changes both increasing and decreasing, safe operation and easy to keep clean.

Projecting perpendicularly and placed substantially central on reactor's outer cylinder wall are enclosed cylindrical tubes 129 and 1. The cylindrical tubes 129 and 130 are positioned substantially vertical from base plate 108. Each cylindrical tube incorporates two attachment points 135 and 136 in a vertical axial configuration. The cylindrical tubes function as ‘grab’ points which enhance the installation and removal of the reactor to the heating unit.

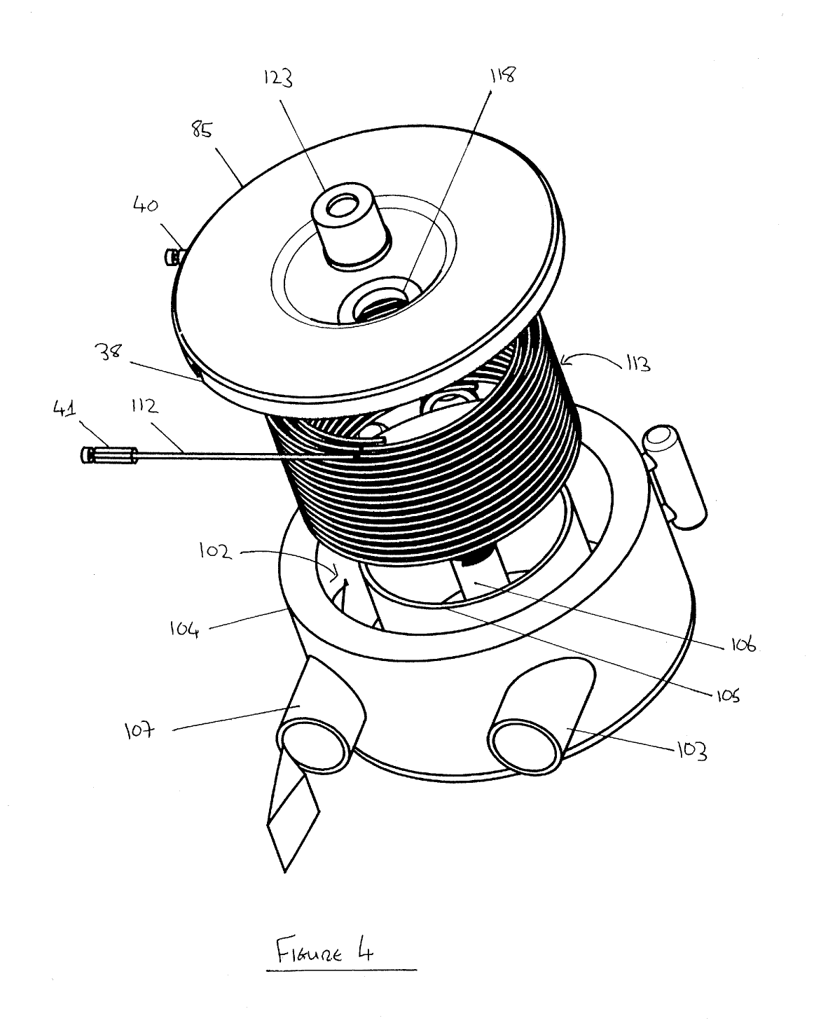

FIG. 4 shows an alternative perspective view of reactor 1a. Two cylindrical couplings 103 and 107 are located perpendicular and substantially central on the reactor's outer cylinder wall. The two cylindrical couplings traverse the reactor's outer cylinder 104 to expel hot air into and out off the annular heating chamber 102. Coupling 103 is configured so that the hot air is applied tangentially to the heating chamber's outer wall 71. Both cylindrical couplings incorporate an annular rim 61 and 62 which is evenly flat in the horizontal axis and the vertical axis.

Coupling 103 is the hot fluid inlet.

FIG. 5 shows a top view of a cross sectional area of the reactor 1a that shows the multiple walls of concentric cylinders. Insulation cavity 70 is of an annular configuration and is formed between the reactor's outer cylinder wall 104 and inner cylinder wall 71. Heating chamber 102 is of an annular configuration and is formed between inner cylinder wall 71 and inner cylinder wall 105. Chamber 77 is of an annular configuration and is formed between inner cylinder wall 105 and column 106 which is located at the heart of the base plate. The column incorporates a hollow cavity 77.

To ensure uniform heating a flow splitter 63 is located where the hot fluid inlet meets the annular heated cavity 102. The flow splitter 63 is used to ensure the correct proportions of the heated fluid travel clockwise and anticlockwise around the heated cavity 102.

Reactor input coupling 103 is cylindrical and traverses the reactor's outer cylindrical walls for hot air to access the heating chamber 102. The input coupling 103 incorporates an annular rim 61 that is externally facing from the reactor and is evenly flat.

Reactor output coupling 107 is cylindrical and traverses the reactor's outer cylindrical walls 4 and 71 to enable the hot air to exit the heating chamber 102. The output coupling incorporates an annular rim 62 that is externally facing the reaction chamber and is evenly flat.

Thermocouple entry tube 125 is cylindrical and perpendicular to the reactor's outer cylinder 104. The thermocouple entry tube 125 traverses the reactor's outer cylindrical wall 104 and abuts against the inner cylindrical wall 71 that is adjacent the heating chamber 102. The thermocouple entry tube incorporates a threaded end portion 128 that is external to the reactor. A screw-fit cap 126 is shown to be screwed into position onto the threaded portion 128 of the thermocouple entry tube 125. The screw fit cap incorporates an aperture 127 that enables a thermocouple to exit the tube whilst being secured into position by the screw-fit cap 126.

Although two specific types of reactor (the columnar and tube types) have been described in detail above, the present invention is not limited to these types of reactor, but can include other known types of reactor.

Whilst examples and embodiments of the present invention have been set out in the preceding description, these are not to be taken as limiting to the scope of the protection. The skilled person will appreciate that variations of these embodiments may be made and that equivalents to any of the features substituted whilst remaining within the scope of the present invention.

1. A heater for supplying heat to a plurality of detachable reactors, the heater including a plurality of independent heating zones, each heating zone including:
a hot-air heater;
an output port adapted for connection to a heating cavity of a reactor;
an exhaust port adapted for connection to the heating cavity of said reactor; and
an air source arranged to cause air heated by said hot-air heater to pass through said output port and to return through said exhaust port when a reactor is attached to said output nozzle and said exhaust port.

2. A heater according to claim 1 wherein the air source is a fan.

3. A heater according to claim 1 wherein each heating zone further includes a temperature sensor for connection to said reactor.

4. A heater according to claim 3 wherein the temperature sensor is a thermocouple.

5. A heater according to claim 3 further including a control unit which is arranged to control said hot-air heater and/or said air source of a heating zone in response to the temperature sensed by said temperature sensor of said heating zone.

6. A heater according to claim 5 wherein the control unit is arranged to control said hot-air heater and/or said air source so as to cause the temperature sensed by said temperature sensor to remain constant at a predetermined level.

7. A heater according to claim 5 further including an input device for setting a target temperature for one of said heating zones, said control unit being arranged to control said hot-air heater and said air source to maintain the temperature sensed by said temperature sensor at said target temperature.

8. A heater according to claim 7 wherein a single input device is arranged to allow the setting of target temperatures for a plurality of said heating zones.

9. A heater according to claim 8 wherein the input device includes a computer connected to said control unit.

10. A heater according to claim 3 further including a display for displaying the temperature of each heating zone.

11. A heater according to claim 2 wherein the fan in each heating zone is arranged to create a pressure at said output port which is greater than atmospheric.

12. A heater according to claim 1 wherein each heating zone includes a fan which is arranged to draw ambient air into an exhaust cavity within the heater where it mixes with hot air arriving at said exhaust port before expelling the mixed air from the heater.

13. A heater according to claim 1 comprising one or more attachment points for each heating zone which are arranged to allow the connection of a plurality of different types of reactor to each of said heating zones.

14. A kit of parts comprising a heater for supplying heat to a plurality of detachable reactors, and at least two different types reactors, wherein:
the heater includes a plurality of independent heating zones, each heating zone including:
a hot-air heater;
an output port adapted for connection to a heating cavity of a reactor;
an exhaust port adapted for connection to the heating cavity of said reactor; and
an air source arranged to cause air heated by said hot-air heater to pass through said output port and to return through said exhaust port when a reactor is attached to said output nozzle and said exhaust port; and further wherein:
each of said types of reactor can be releasably connected to any one of said independent heating zones.

15. A kit of parts according to claim 14 wherein said types of reactor include a homogeneous reactor and a heterogeneous reactor.

16. A kit of parts according to claim 14 wherein at least one of said types of reactor includes:
a first cavity through which flows, in use, a fluid to be analysed or reacted; and
a second cavity through which flows, in use, the hot air from said heater.

17. A kit of parts according to claim 16 wherein the walls of said cavities are constructed so as to allow the fluid flowing in said first cavity to be viewed.

18. A kit of parts according to claim 16 wherein the second cavity is arranged so as to cause agitation of the hot air flowing through said second cavity.

19. A kit of parts according to claim 18 wherein the second cavity has an intake port which is arranged to connect to the output port of one of said heating zones, the intake port being arranged so as to induced a swirled flow of air in said second cavity.

20. A kit of parts according to claim 16, wherein each heating zone further includes a temperature sensor, said temperature sensor and said reactors being arranged such that the temperature sensor is positioned in said second cavity and detects the temperature of a wall separating said first cavity and said second cavity.

21. A kit of parts according to claim 16, wherein the reactor further includes a third cavity arranged to insulate said second cavity and prevent heat loss to the atmosphere.

22. Apparatus for flow chemistry including a heater and a plurality of types of reactor detachably connected to said heater and arranged to be heated by said heater, wherein:
each of said types of reactor has a first cavity through which flows, in use, a fluid to be analysed or reacted; and a second cavity through which flows, in use, hot air from said heater;
the heater includes a plurality of independent heating zones, each heating zone including:
a hot-air heater;
an output port connected to the second cavity of one of said reactors;
an exhaust port connected to the second cavity of said reactor;
an air source arranged to cause air heated by said hot-air heater to pass through said output port and to return through said exhaust port.
